(19) United States
(12) Patent Application Publication
(10) Pub. No.: US 2006/0047010 A1
(43) Pub. Date: Mar. 2, 2006

(54) Pseudo one part foam

(76) Inventor: Robert J. O'Leary, Newark, OH (US)

Correspondence Address: OWENS CORNING, 2790 COLUMBUS ROAD, GRANVILLE, OH, 43023, US

(21) Appl. No.: 10/932,780

(22) Filed: Sep. 2, 2004

(51) Int. Cl. C08G 18/00

(52) U.S. Cl. 521/155

(57) ABSTRACT

A spray polyurethane foam formed by reacting an isocyanate prepolymer composition (“A” side) with a isocyanate reactive composition encapsulated in a long-chain inert polymer (“B” side) is provided. The isocyanate prepolymer composition may contain an isocyanate prepolymer that contains less than about 1 wt % free isocyanate monomers, a blowing agent, and a surfactant. The isocyanate prepolymer is an NCO-terminated oligomer formed by reacting at least one isocyanate with one or more polyols. The isocyanate reactive composition may contain a polyol or a mixture of polyols that will react with isocyanate groups and a catalyst. To form a polyurethane foam, the “A” side and the “B” side are mixed into a non-reactive slurry. The slurry is fed into an application gun where it is heated. The heat melts the polymer matrix and releases the polyols and catalyst. The polyols react with the isocyanate prepolymer and form the polyurethane foam.

### TECHNICAL FIELD AND INDUSTRIAL APPLICABILITY OF THE INVENTION

The present invention relates generally to polyurethane foams, and more particularly, to spray polyurethane foams in which the isocyanate prepolymer contains less than about 1 wt % free isocyanate monomers.

### BACKGROUND OF THE INVENTION

Polyurethane foams have found widespread utility in the fields of insulation and structural reinforcement. For example, polyurethane foams are commonly used to insulate or impart structural strength to items such as automobiles, hot tubs, refrigerators, boats, and building structures. In addition, polyurethane foams are used in applications such as cushioning for furniture and bedding, padding for underlying carpets, acoustic materials, textile laminates, and energy absorbing materials.

Polyurethane spray foams and their methods of manufacture are well known. Typically, polyurethane spray foams are formed from two separate components, commonly referred to as an “A” side and a “B” side, that react when they come into contact with each other. The first component, or the “A” side, contains an isocyanate such as a di- or poly-isocyanate that has a high percent NCO. The second component, or “B” side, contains polyols that contain two or more active hydrogens, silicone-based surfactants, blowing agents, catalysts, and/or other auxiliary agents. The active hydrogen-containing compounds are typically polyols, primary and secondary polyamines, and/or water. Preferably, mixtures of diols and triols are used to achieve the desired foaming properties. The overall polyol hydroxyl number is designed to achieve a 1:1 ratio of first component to second component.

The two components are delivered through separate lines into a spray gun, such as an impingement-type spray gun. The first and second components are pumped through small orifices at high pressure to form streams of the individual components. The streams of the first and second component intersect and mix with each other within the gun and begin to react. The heat of the reaction causes the temperature of the reactants in the first and second components to increase. This rise in temperature causes the blowing agent located in the second component (“B” side) to vaporize and form a foam. As the mixture leaves the gun, the mixture contacts a surface, sticks to it, and continues to react until the isocyanate groups have completely reacted. The resulting resistance to heat transfer, or R-value, may be from about 4 to about 8 per inch.

Several reactions occur during the preparation of the polyurethane foam. In the primary reaction, the isocyanate and the polyol or polyamine react to form a crosslinked polymer. The progress of this reaction increases the viscosity of the mixture until a crosslinked solid is formed. In addition, the heat generated by the primary reaction vaporizes the blowing agent. As the blowing agent becomes a gas, it forms a foam. If water is present in the “B” side of the mixture, a secondary reaction between the water and the isocyanate occurs. In this reaction, the water and the isocyanate react to form carbon dioxide, which mixes with the reacting polymer to help form the foam.

One problem with such conventional polyurethane spray foams is that the first component (“A” side) contains high levels of methylene-diphenyl-di-isocyanate (MDI) monomer. When the reactants are sprayed, the MDI monomer forms droplets that may be inhaled by workers installing the foam if stringent safety precautions are not followed. A brief exposure of isocyanate monomers may cause irritation to the nose, throat, and lungs, difficulty in breathing, and skin irritation and/or blistering. Extended exposure of these monomers can lead to a sensitization of the airways, which may result in an asthmatic-like reaction and possibly death.

Another problem with such conventional polyurethane spray foams is that residual polymeric methylene-diphenyl-di-isocyanate (PMDI) that is not used is considered to be a hazardous waste. Therefore, specific procedures must be followed to ensure that the waste product is properly and safely disposed of in a licensed land fill. Such precautions are costly and time consuming.

Thus, there exists a need in the art for a polyurethane spray foam that is safe for workers and which is environmentally friendly.

### SUMMARY OF THE INVENTION

It is an object of the present invention to provide a reaction system for preparing a polyurethane foam that includes an isocyanate prepolymer composition (“A” side) and an isocyanate reactive composition encapsulated in a polymer (“B” side). The isocyanate prepolymer composition includes an isocyanate prepolymer, which is an NCO-terminated oligomer formed by reacting at least one isocyanate with one or more polyols. The isocyanate prepolymer composition may also be formed by reacting one or more isocyanates with at least one polyamine. Examples of suitable isocyanates include methylene-diphenyl-di-isocyanate (MDI), polymeric-methylene-diphenyl-di-isocyanate (PMDI) and toluene-diphenyl-di-isocyanate (TDI). The polyols used to form the isocyanate prepolymer may be of any type that will form a solution with the blowing agent and form a closed cell structure in the foam. Preferred polyol examples include polyether polyols and polyester polyols. The polyols preferably have functionalities between 2 and 8, and even more preferably, functionalities from 2 to 4. The molecular weight of the polyols may range from about 700 to about 10,000. In addition, the isocyanate prepolymer composition may include a blowing agent. The blowing agent may act as a plasticizer and lower the viscosity of the isocyanate prepolymer. The “A” side may also include a surfactant, a flame retardant, a colorant, and a biocide, as well as any other suitable conventional additives.

The isocyanate reactive composition contains at least one polyol that is reactive with the isocyanate groups present in the “A” side and a catalyst. In preferred embodiments, the polyol(s) are chain extending or crosslinking polyols. These short chain polyols are known as chain extenders for bifunctional reactants and crosslinking agents for functionalities of three or more. The polyol(s) and catalyst are encapsulated in a long-chain, inert polymer. It is preferred that the encapsulating polymer have a melting point of from approximately about 120 to about 180° F. Suitable polymers include polypropylene oxide (PPO) and polyethylene oxide (PEO). The long chain of the polymer and hydrogen bonding between the polyol and the catalyst provides a network or matrix for the polyol/catalyst encapsulation. The ratio of the isocyanate prepolymer composition to the isocyanate reactive composition may range from 2:1-30:1.

It is another object of the present invention to provide a method of forming a polyurethane foam. In at least one exemplary embodiment, the polyurethane foam is formed by first admixing the isocyanate prepolymer composition and the encapsulated isocyanate reactive composition, preferably at the time of application, to form a slurry. The slurry is substantially non-reactive because the catalyst and the polyol(s) remain encapsulated within the polymer after the isocyanate prepolymer composition and the encapsulated isocyanate reactive composition are mixed. The ratio of the isocyanate prepolymer composition:isocyanate reactive composition may range from 2:1-30:1 respectively. The slurry may then be fed into an application device, such as an application gun, where the slurry is mixed and heated to melt the polymer and release the polyol(s) and catalyst. It is preferred that the amount of isocyanate prepolymer composition present in the slurry be substantially larger than the amount of the isocyanate reactive product so that the slurry can be easily distributed into the application device. Once the polyol(s) and catalyst are free from the polymer matrix, the polyol(s) and the isocyanates begin to react and form a polyurethane foam. The reacting mixture may then be sprayed to a desired location where the reaction continues until all of the isocyanates are reacted. Typical R values may range from about 4 to about 8 per inch.

It is a further object of the present invention to provide an insulation product which is the reaction product of an isocyanate prepolymer composition (“A” side) and a “B” side containing an isocyanate reactive composition encapsulated in an inert polymer. The isocyanate prepolymer composition contains an isocyanate prepolymer that is formed by reacting at least one isocyanate and one or more polyols. The polyols are preferably polyether or polyester polyols. Alternatively, the isocyanate prepolymer is formed by reacting at least one isocyanate with one or more polyamines. The isocyanate reactive composition contains at least one polyol and catalyst. The polyol(s) and the catalyst are encapsulated in an inert polymer that may have a molecular weight of from about 100,000 to about 8,000,000. In preferred embodiments, the polymer is polyethylene oxide or polypropylene oxide. The ratio of the “A” side to the “B” side may range from 2:1-30:1.

It is an advantage of the present invention that virtually no free isocyanate monomers are released when the polyurethane foam is sprayed. Thus, the foam is safe for workers to install. The inventive foam can be used in the house renovation market and in houses that are occupied.

It is another advantage of the present invention that the residual isocyanate prepolymer composition and isocyanate reactive composition that remain unused in the slurry will, over a period of days, react to form an inert and non-hazardous waste that can be safely land filled without following any stringent hazardous waste precautions.

The foregoing and other objects, features, and advantages of the invention will appear more fully hereinafter from a consideration of the detailed description that follows.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. It is to be noted that the phrase “isocyanate prepolymer composition” may be used interchangeably with the phase “A” side.

The present invention relates to a spray polyurethane foam that is formed by reacting an isocyanate prepolymer composition (“A” side) having an NCO content of from about 1 to about 15 wt % with a “B” side containing an isocyanate reactive composition encapsulated in a long-chain, high molecular weight polymer. The isocyanate reactive composition contains a polyol or a mixture of polyols that will react with the isocyanate groups in the isocyanate prepolymer composition and a catalyst.

The isocyanate prepolymer composition (“A” side) contains an isocyanate prepolymer, which is an NCO-terminated oligomer formed by reacting at least one isocyanate with one or more polyols. Alternatively, one or more polyamines may be reacted with the isocyanate to form the isocyanate prepolymer. Suitable isocyanates, or reactive NCO-containing compounds, which may be used in forming the isocyanate prepolymer include, but are not necessarily limited to, methylene-diphenyl-di-isocyanate (MDI); polymeric-methylene-diphenyl-di-isocyanate (PMDI); toluene-diphenyl-di-isocyanate (TDI); 2,4-toluene di-isocyanate; 1,6-hexamethylene di-isocyanate; 1,4-di-isocyanate; 2,6-toluene di-isocyanate; 2,4-diphenylmethane di-isocyanate; p-phenylene di-isocyanate; polymethylene polyphenylisocyanate; diphenyl-methane di-isocyanate; m-phenylene di-isocyanate; hexamethylene di-isocyanate; butylene-1,4-di-isocyanate; octamethylene di-isocyanate; 3,3′-dimethoxy-4,4′-biphenylene di-isocyanate; 1,1 8-octadecamethylene di-isocyanate; polymethylene di-isocyanate; benzene triisocyanate; naphthylene-2,4-di-isocyanate; 3,3′-dimethyl-4,4′-biphenylene di-isocyanate; 1-methoxy phenylene-2,4-di-isocyanate; diphenylene-4,4′-di-isocyanate; 4,4′-di-isocyanate diphenyl ether; naphthylene-1,5-di-isocyanate; di-isocyanate-diclyclohexyl-methane; p-xylylene di-isocyanate; 1,4-xylyene-di-isocyanate; xylylene di-isocyanate; hydrogenated diphenylene di-isocyanate; hydrogenated diphenyl methane di-isocyanate; toluene-2,4,6-triisocyanate; 3-methyl-4,6,4′-triisocyanate diphenyl methane; 2,4,4′-triisocyanate diphenyl; 2,4,4′-triisocyanate diphenyl ether; long chain hydrocarbons and substituted hydrocarbons terminated with NCO radicals; and mixtures thereof. Prepolymers having reactive isocyanate or NCO groups, such as Rubinate 9448 commercially available from Huntsman Corporation, may also be used.

The polyol used to form the isocyanate prepolymer may be of any type that will form a solution with the blowing agent and a closed cell structure in the foam. Non-limiting examples of suitable polyols include polyether polyols and polyester polyols. The polyols may have average functionalities of from 2-8, and preferably from 2-4. The average molecular weight for the polyols may range from about 700 to about 10,000. Polyurethane dispersion polyols, polyurea dispersion polyols, polyhydroxy-containing phosphorous compounds, alkylene oxide adducts of polyhydric polythioesters, polyacetal polyols, and aliphatic polyols and thiols are also suitable for use in the instant invention.

In addition, any suitable polyether polyol may be used. An example of a suitable polyether polyol includes the polymerization product of an alkylene oxide or a mixture of alkylene oxides (e.g., ethylene oxide or propylene oxide) with a polyhydric alcohol initiator, such as, but not limited to ethylene glycol; 1,2-propylene glycol; 1,3-propylene glycol; 1,4-butylene glycol; 1,2-butylene glycol; 2,3-butylene glycol; 1,6-hexane diol; 1,8-octane diol; neopentyl glycol; cyclohexane dimethanol (1,4-bis-hydroxymethyl cyclohexane) 2-methyl-1,3-propane diol; glycerol; trimethylol propane; 1,2,6-hexane triol; 1,2,4-butane triol; trimethylol ethane; pentaerythritol; quinitol; mannitol; sorbitol; methyl glycoside; diethylene glycol; triethylene glycol; tetraethylene glycol; polyethylene glycol; propylene glycol; dipropylene glycol; polypropylene glycols; dibutylene glycol; polybutylene glycols; cyclohexane dimethanol; resorcinol; glycerol; and the like. In addition, compounds derived from phenols such as 2,2-bis(4-hydroxylphenyl)propane, commonly known as Bisphenol A, may be used to react with the alkylene oxide(s) to form a polyether polyol. The functionality of the polyol will depend on the functionality of the chosen initiator.

Polyester polyols suitable for use in the present invention may be prepared by the condensation of an alkene glycol and a corresponding diether or diacid. One example is the reaction of 1,4-butanediol with adipic acid to form polybutanediol adipate. Any suitable polycarboxylic acid may be used to form the polyester polyol. Non-limiting examples of polycarboxylic acids include oxalic acid, malonic acid, succinic acid, glutaric acid, adipic acid, pimelic acid, suberic acid, azelaic acid, sebacic acid, brassylic acid, thapsic acid, maleic acid, fumaric acid, glutaconic acid, α-hydromuconic acid, β-hydromuconic acid, α-butyl-α-ethyl-glutaric acid, α, β-diethylsuccinic acid, isophthalic acid, terephthalic acid, hemimellitic acid, dimethylol propionic acid, and 1,4-cyclohexanedicarboxylic acid. A polyhydric alcohol initiator such as ethylene glycol; 1,2-propylene glycol; 1,3-propylene glycol; 1,4-butylene glycol; 1,2-butylene glycol; 2,3-butylene glycol; 1,6-hexane diol; 1,8-octane diol; neopentyl glycol; cyclohexane dimethanol (1,4-bis-hydroxymethyl cyclohexane) 2-methyl-1,3-propane diol; glycerol; trimethylol propane; 1,2,6-hexane triol; 1,2,4-butane triol; trimethylol ethane; pentaerythritol; quinitol; mannitol; sorbitol; methyl glycoside; diethylene glycol; triethylene glycol; tetraethylene glycol; polyethylene glycol; propylene glycol; dipropylene glycol; polypropylene glycols; dibutylene glycol; polybutylene glycols; cyclohexane dimethanol; resorcinol; bisphenol A; glycerol, and mixtures thereof may also be used to form the polyester polyol.

Suitable polyamines for use in forming the isocyanate prepolymer include any of the above-identified polyethers in which the alcohol groups are replaced with primary or secondary amino functionalities.

The isocyanate prepolymer is formed by reacting at least one isocyanate and either (1) one or more polyols or (2) one or more polyamines as described above. The isocyanate prepolymer has a low NCO content. Preferably, the NCO content is from about 1 to about 15 wt %. In addition, the isocyanate prepolymer contains less than about 1 wt % free isocyanate monomer. In at least one embodiment, the isocyanate prepolymer is formed of a mixture of diol and triol polyols having a molecular weight of from about 200 to about 8,000. The ratio of diol to triol and the equivalent weights of these moieties will determine not only the viscosity and flow characteristics of the isocyanate prepolymer but also the quality of the foam cell formation. The triol provides the branching needed for cell wall strength and the diol provides flowability and resilience.

In addition to the isocyanate prepolymer, the isocyanate prepolymer composition (“A” side) may optionally contain one or more blowing agents. Generally, a prepolymer with a low NCO content has a viscosity in the range of from about 50,000 to about 500,000 centipoises. Such a high viscosity prohibits the ability of the isocyanate prepolymer composition to be pumped through a spray gun. In this regard, a blowing agent may be added to lower the viscosity of the prepolymer composition. The blowing agent has a high miscibility in the prepolymer composition and will act as a plasticizer and lower the viscosity. Preferably, the blowing agent lowers the viscosity to approximately about 100 to about 20,000 centipoise at room temperature. Examples of blowing agents which may be used in the isocyanate prepolymer composition include low boiling point hydrocarbons such as cyclopentane and n-pentane, water, and inert gases such as air, nitrogen, and carbon dioxide. The amount of the blowing agent that may be used in the isocyanate prepolymer composition is not particularly limited, but preferably falls within the range of about 5 to about 20% by weight of the “A” side. Specific examples of suitable blowing agents include HFC 236ca (1,1,2,2,3,3-Hexafluoropropane), HFC-236ea (1,1,1,2,3,3-hexafluoropropane), HFC-236fa (1,1,1,3,3,3-hexafluoropropane), HFC-245ca (1,1,1,2,2,3-hexafluoropropane), HFC-245ea (1,1,2,3,3-pentafluoropropane), HFC-245eb 1,1,1,2,3 pentafluoropropane), HFC-245fa (1,1,1,3,3-pentafluoropropane), HFC-356mff (1,1,1,4,4,4-hexafluorobutane), HFC-365mfc (1,1,1,3,3-pentafluorobutane), and HCFC141b (2-fluoro 3,3-chloropropane). HFC-245fa (1,1,1,3,3-pentafluoropropane) is particularly preferred as the blowing agent.

Further, the isocyanate prepolymer composition may optionally contain one or more surfactants to impart stability to the urethane during the foaming process, to provide a high surface activity for the nucleation and stabilization of the foam cells, and to obtain a finely distributed, uniform foam. In addition, the surfactant permits the reacting components (e.g., isocyanate prepolymer and polyol) and the gaseous blowing agent to form a stable emulsion. Suitable surfactants for use in the prepolymer composition include DABCO® DC 197, DABCO® DC 5098, and DABCO® 120, all of which are silicone glycol copolymers commercially available from Air Products, polydimethylsiloxanes having a relatively low viscosity, and silicones such as, but not necessarily limited to, polyalkylsiloxane-polyoxalkylene copolymers. The surfactant may be present in the isocyanate prepolymer composition in an amount of from about 0.1 to about 5% by weight of the “A” side.

Flame retardants may also be added to the “A” side to render the polyurethane foam flame retardant. Suitable flame retardants include tris(chloroethyl) phosphate, tris(2-chloroethyl) phosphate, tris(dichloropropyl) phosphate, chlorinated paraffins, tris(chloropropyl) phosphate, phosphorus-containing polyols, and brominated aromatic compounds such as pentabromodiphenyl oxide and brominated polyols. The flame retardant is preferably present in an amount of from about 1 to about 10% by weight of “A” side.

Other additives such as colorants (diazo or benzimidazolone family of organic dyes), biocides, and blocking agents may be present in the isocyanate prepolymer composition.

As described above, the isocyanate reactive composition contains at least one polyol that is reactive with the isocyanate groups present in the isocyanate prepolymer composition (“A” side). It is preferred that the polyols used in the “B” side are of the type known as chain extenders or crosslinking agents. Chain extenders or crosslinking agent polyols have high hydroxyl indices and low molecular weights. Suitable chain extender or crosslinking polyols for use in the instant invention include, but are not limited to, 1,4 butane diol; ethylene diamine 1,4 cyclohexanededimethanol; 1,2,3, propane triol; 1,6 hexane diol; hydroquinone; N,N,N′,N′ tetrakis (2-hydroxyethyl) ethyl diamine d-glucitol; and trimethylol propane. The chain extender or crosslinking polyols may be present in the “B” side in an amount of from approximately 1 to about 20 wt % on the basis of the polyols and isocyanates. Preferably, the polyols are present in an amount of less than about 10 wt %.

Any suitable catalyst may be employed in the isocyanate reactive composition. Examples of suitable catalysts include tertiary amines such as, for example, triethylenediamine, N-methylmorpholine, N-ethylmorpholine, diethylethanolamine, N-cocomorpholine, 1-methyl-4-dimethylaminoethylpiperazine, 3-methoxypropyldimethylamine, N,N,N′-trimethyl isopropyl propylenediamine, 3-diethylaminopropyldiethylamine, and dimethylbenzylamine. Other suitable catalysts include, for example, stannous chloride, dibutyltin di-2-ethyl hexanoate, stannous oxide, as well as other organometallic compounds, and DABCO® 125, DABCO® 120, DABCO® 131, and DABCO® DC2 (available commercially from Air Products). The catalyst may be present in an amount of from approximately 0.02 to about 2.0% by weight of the “B” side.

The polyol or polyols and the catalyst are encapsulated in a long chain, high molecular weight inert polymer. The polymer is desirably a polymer having a molecular weight of from about 100,000 to about 8,000,000 and a low melting point. In particular, it is preferred that the polymer has a melting point of from about 120 to about 180° F., and it is most preferred that the melting point be in the range of from about 143 to about 153° F. Examples of suitable encapsulating polymers include, but are not limited to, polypropylene oxide (PPO) and polyethylene oxide (PEO). A preferred polymer for use in the present invention is polyethylene oxide.

In at least one embodiment of the invention, the polyol(s) and the catalyst are mixed together prior to encapsulation by the polymer. The long chain of the polymer and hydrogen bonding between the polyol(s) and the catalyst provides a network or matrix for the polyol/catalyst encapsulation. The polymer/polyol/catalyst matrix exists in a solid form. The polymer, polyol(s), and catalyst are mixed by first melting the polymer and then adding the polyol(s) and catalyst to the melted polymer. This molten solution may be formed into a powder in a variety of ways that are familiar to those skilled in the art. For example, the molten solution may be poured onto a heated disk spinning at high speed. As the molten solution reaches the edge of the disk, it experiences surface instability which breaks the liquid sheet into small particles which freeze in the air. The frozen particles that make up the solid solution of polymer, polyol(s), and catalyst are collected into a collection bin.

To form a rigid polyurethane foam, the isocyanate prepolymer composition (“A” side) and the solid isocyanate reactive composition (“B” side) are mixed to form a slurry. It is to be noted that there is substantially no reaction between the isocyanate prepolymer composition and the isocyanate reactive composition in the two part component slurry. The phrase “substantially no reaction” as used herein is meant to indicate that there is no reaction or only a minimal reaction between the isocyanate prepolymer composition and the isocyanate reactive composition. The ratio of isocyanate prepolymer composition:isocyanate reactive composition may range from 2:1-30:1. Preferably, the isocyanate prepolymer composition:isocyanate reactive composition is 10:1-30:1. It is preferred that the amount of the isocyanate prepolymer composition present in the slurry be substantially larger than the amount of the isocyanate reactive composition to ensure that the slurry contains a low solids content. The low percent NCO of the prepolymer (e.g., between about 1 to about 15 wt %) permits the use of a small amount of chain extender or crosslinking agent (polyol) to achieve a fully cured polymer. The isocyanate prepolymer preferably has an NCO content of approximately 1 to about 5 wt % before mixing with the “B” side. In a preferred embodiment, the viscosity of the isocyanate prepolymer composition will have a viscosity similar to the viscosity of the “B” side to facilitate mixing of the “A” and the “B” sides.

A single stream of the two component slurry containing the “A” and “B” side may then be fed into an application gun, such as a spray gun, that has the ability to mix and/or heat the slurry within the gun. The slurry is heated within the gun to a temperature above the melting point of the long chain polymer containing the polyol and catalyst so that the polyols and catalyst are released from the polymer. In preferred embodiments, the slurry is heated to a temperature of approximately 140 to about 180° F. The heat imparted by the gun at least partially melts the polymer crystallites into a liquid and allows the polyols and catalyst to mix with the isocyanate prepolymer. In addition, the mixing action within the gun assists in the release of the polyols and catalyst from the polymer.

Once the polyols and catalyst have been released from the polymer matrix, the polyols and the isocyanate begin to chemically react. The reacting mixture that leaves the gun contains less than about 1 wt % free isocyanate monomer, preferably less than about 0.1 wt % free isocyanate monomer. The heat of the reaction (and also the heat of the gun) causes the temperature of the reactants to increase. Once the temperature of the blowing agent reaches its boiling point, the blowing agent vaporizes and creates a foamed product. The reacting mixture is sprayed from the gun to a desired location where the mixture continues to react and form a polyurethane foam. The foam may have an R-value of from about 4 to about 8 per inch. The foam is advantageously used as an insulation product, such as, for example, in residential housing, commercial buildings, appliances (e.g., refrigerators and ovens), and hot tubs.

In an alternate embodiment of this invention, the inert polymer of the “B” side contains a catalyst or a combination of catalysts and no polyols. In this alternative embodiment, the polyol (e.g., chain extender or crosslinking polyol) that was encapsulated in the inert polymer (as described in detail above) is instead added to the “A” side at the time of application along with the polymer-encapsulated catalyst. Thus, the isocyanate reactive composition contained in the “B” side contains only the catalyst. The chain extender polyol and the isocyanate prepolymer do not readily react until the catalyst is released from the polymer, such as by with heat. As a result, the slurry that is formed by admixing the isocyanate prepolymer, chain extender polyol, and polymer-encapsulated catalyst is substantially non-reactive. If additional shelf life is required, a blocking agent such as butanone oxime may be employed with the isocyanate to reduce ambient temperature reactions. Other suitable blocking agents would be easily identified by one of skill in the art. In addition, the blocking agent may be pre-reacted with the isocyanate prepolymer at the time of its manufacture. One particular advantage of this embodiment is that the ratio of isocyanate prepolymer composition:isocyanate reactive composition may be approximately 60:1.

One advantage of the high ratio spray foam according to the invention is that little or no isocyanate monomers are emitted during the foam's formation. As a result, the spray foam reduces the threat of harm to individuals working with or located near the foam. Another advantage provided by the present invention is that the residual isocyanate prepolymer composition and isocyanate reactive composition that remain unused in the slurry will, over a period of days, react to form an inert and non-hazardous waste that can be safely land filled. This reaction may occur in various ways at ambient conditions. For example, the polymer encapsulant may dissolve with time and release the catalyst/polyol mixture and form an inert composition. As another example, the NCO present in the “A” side may react with atmospheric moisture to become a non-hazardous solid. In either example, the isocyanate prepolymer is closer to the gel point than the standard 1:1 ratio rigid spray foams and will quickly react to form an inert product.

Another advantage of the inventive foam is that it can be used in the renovation market and in houses that are occupied. Existing, conventional two-part foams cannot be used in these applications because of the generation of high amounts of free isocyanate monomers that could adversely affect the occupants of the dwelling. As discussed above, exposure of isocyanate monomers may cause irritation to the nose, throat, and lungs, difficulty in breathing, skin irritation and/or blistering, and a sensitization of the airways.

Having generally described this invention, a further understanding can be obtained by reference to certain specific examples illustrated below which are provided for purposes of illustration only and are not intended to be all inclusive or limiting unless otherwise specified.

### EXAMPLE

Table 1 sets forth a list of proposed components that may be used to make at least one example of the inventive foam.

TABLE 1
Proposed Components

| | |
|---|---|
| Polyol A | a glycerol/ethylene oxide/propylene oxide |
| | having a hydroxyl number of 41.6, a |
| | functionality of 3, and an average molecular |
| | weight of 4,000 |
| Polyol B | a propylene oxide glycol with a hydroxyl |
| | number of 55, a functionality of 2, and an |
| | average molecular weight of 2,000 |
| Polyol C | a propylene glycol with a hydroxyl number |
| | of 164, a functionality of 3, and an average |
| | molecular weight of 1,000 |
| Polyol D | 1,4-butanediol |
| Isocyanate A | a polymeric MDI having a percent NCO of |
| | 31.2, an equivalent weight of 133, and a |
| | functionality of 2.7 |
| Isocyanate B | a pure 4,4′-MDI having a percent NCO of |
| | 33.5, an equivalent weight of 125, and a |
| | functionality of 2 |
| DABCO ® T-120 | a dibutyltin dimercaptide gel catalyst sold |
| | by Air Products |
| DABCO ® T-125 | an organotin gelation catalyst commercially |
| | available from Air Products |
| DABCO ® T-9 | a stannous octoate type catalyst |
| | commercially available from Air Products |
| DABCO ® DC 197 | a silicone glycol copolymer surfactant |
| | commercially available from Air Products |
| DABCO ® DC 5098 | a non-hydrolyzable silicone surfactant |
| | commercially available from Air Products |
| PEO | an 8,000,000 molecular weight |
| | polyethylene oxide with a melting point of |
| | approximately 143 to 153° F. |
| Fyrol PCF | a tris(2-chloropropyl) phosphate flame |
| | retardant commercially available from Akzo |
| | Nobel |
| FHC 245fa | a hydrofluorocarbon blowing agent |
| | commercially available from Allied Signal |
| Colorant | a diazo organic dye |
| Biocide | a quaternary ammonium silane |

Prophetic examples of an “A” side and a “B” side using the components identified in Table 1 are set forth in Tables 2 and 3 respectively. The foam ratio is set forth in Table 4.

TABLE 2
Examples of “A” side components

| | Example 1 | Example 2 | Example 3 |
|---|---|---|---|
| | (parts by | (parts by | (parts by |
| | weight) | weight) | weight) |
| Polyol A | 300 | 500 | |
| Polyol B | 600 | 500 | 400 |
| Polyol C | | | 600 |
| Polyol D | | | 94 |
| Isocyanate A | 125 | 134 | 0 |
| Isocyanate B | | | 261 |
| DABCO ® T-125 | | | 3 |
| (catalyst) | | | |
| DABCO ® T-9 | 3 | 3 | |
| (catalyst) | | | |
| DABCO ® DC 197 | 4 | | 5 |
| (surfactant) | | | |
| DABCO ® DC 5098 | | 5 | |
| (surfactant) | | | |
| 153 PCF Fyrol | 81 | 85 | 80 |
| (flame retardant) | | | |
| HFC 245fa | 216 | 239 | 266 |
| (blowing agent) | | | |
| Biocide | 13 | 15 | 17 |
| Colorant | 6.7 | 7.5 | 8.3 |
| Total | 1348.7 | 1488.5 | 1734.3 |

TABLE 3
Examples of “B” side components

| | Example 1 | Example 2 | Example 3 |
|---|---|---|---|
| | (parts by | (parts by | (parts by |
| | weight) | weight) | weight) |
| PEO polymer | 46.1 | 50.2 | 25.1 |
| Polyol D | 46.1 | 50.2 | 0 |
| DABCO ® T-120 | 2.04 | 2.26 | 2.51 |
| (catalyst) | | | |
| Total | 94.24 | 102.66 | 27.61 |

TABLE 4
Foam Ratio

| | Example 1 | Example 2 | Example 3 |
|---|---|---|---|
| “A” side:Polyol D | 29.3:1 | 29.7:1 | N/A |

In Example 1, 22 wt % of a Polyol A and 44 wt % of a Polyol B is reacted with 9.3 wt % of Isocyanate A. The percent NCO of these three components is 4.84. In Example 2, 34 wt % of a Polyol A and 34 wt % of a Polyol B is reacted with 9 wt % of Isocyanate A. The percent NCO of these three components is 4.75. In Example 3, 24 wt % of a Polyol B and 36.5 wt % of Polyol C are reacted with 15.9 wt % of Isocyanate B. The percent NCO of the three components is 8.22.

Examples 1 and 2 represent two different low levels of branching using the same reactants and where the B side polyol is encapsulated with the catalyst. In Example 3, a lower equivalent weight triol and a polymeric MDI is used to achieve a more branched polymer. In Example 3, the “B” side polyol is not incorporated in the encapsulant, it is added to the “A” side at the time of foam application. The “B” side contains only the catalyst. One particular advantage of this configuration is that the ratio of isocyanate prepolymer:catalyst may be in the range of 60:1.

Proposed Isocyanate Prepolymer Composition (“A” side) Procedure

Begin with a pressure rated, agitated reactor that has the capability to be heated, cooled, and nitrogen purged. A portion of the HFC 245fa blowing agent, e.g., between about 10 and to about 50 wt %, is mixed with the isocyanate and polyols and is placed into a reactor that is less than 60° F. The sealed headspace of the reactor is purged with nitrogen and the agitator is started. The reactor is then heated to approximately 110° F. The remainder of the HFC 245fa is mixed with the catalyst, surfactant, biocide, and flame retardant and pumped into the heated reactor. An exotherm should be observed. After the exotherm has reached its plateau, the reactor is cooled to below 60° F.

Proposed Isocyanate Reactive Composition (“B” side) Procedure

A clean, dry, nitrogen purged, agitated reactor with a heated tube exiting the bottom of the reactor is used to form the isocyanate reactive composition (“B” side). The reactor is capable of heating up to 200° F. Place a prescribed amount of PEO in the reactor and heat until completely melted. The PEO melts between approximately 143° F. and 153° F. Add the prescribed amount of catalyst and polyol D. Mix until a homogenous solution is formed. Pressurize the reactor with nitrogen and open the valve to the heated bottom drain tube. Preferably, the tube exits onto the center of a heated, spinning disk. The molten mixture moves toward the outside perimeter of the spinning disk by virtue of centrifugal force. At the edge of the disk, the molten solution breaks up into small droplets. The size of the droplets depends on the rheology of the fluid, the speed of the disk, the flow rate of the molten solution, and the size of the disk. The droplets freeze into a solid as they travel through the air and are collected into a collection bin.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

Having thus described the invention, what is claimed is:

1. A reaction system for preparing a polyurethane foam comprising:
an isocyanate prepolymer composition including an isocyanate prepolymer, and
an isocyanate reactive composition including at least one first polyol and a catalyst, said isocyanate reactive composition being encapsulated in an inert polymer.

2. The reaction system of claim 1, wherein said reaction system has an isocyanate prepolymer composition:isocyanate reactive composition ratio of from 2:1-30:1.

3. The reaction system of claim 1, wherein said isocyanate prepolymer contains less than about 1 wt % free isocyanate monomers.

4. The reaction system of claim 1, wherein said isocyanate prepolymer is the reaction product of at least one isocyanate and a member selected from the group consisting of one or more second polyols and one or more polyamines.

5. The reaction system of claim 4, wherein said at least one isocyanate is selected from the group consisting of methylene-diphenyl-di-isocyanate, polymeric-methylene-diphenyl-di-isocyanate and toluene-diphenyl-di-isocyanate.

6. The reaction system of claim 4, wherein said one or more second polyols is selected from the group consisting of polyether polyols and polyester polyols.

7. The reaction system of claim 4, wherein said isocyanate prepolymer composition further includes one or more blowing agents.

8. The reaction system of claim 7, wherein said blowing agent acts as a plasticizer to lower the viscosity of said isocyanate prepolymer composition.

9. The reaction system of claim 1, wherein said isocyanate prepolymer composition further includes at least one member selected from the group consisting of surfactants, flame retardants, colorants and biocides.

10. The reaction system of claim 1, wherein said polymer has a molecular weight of from about 100,000 to about 8,000,000.

11. The reaction system of claim 10, wherein said polymer is selected from the group consisting of polyethylene oxide and polypropylene oxide.

12. The reaction system of claim 10, wherein hydrogen bonding between said second polyol and said catalyst provides a matrix for encapsulation in said polymer.

13. The reaction system of claim 1, wherein said encapsulated isocyanate reactive composition exists in a solid form.

14. The reaction system of claim 4, wherein said isocyanate prepolymer has an NCO content of from about 1 to about 15 wt %.

15. The reaction system of claim 1, wherein said second polyol is selected from the group consisting of 1,4 butane diol, ethylene diamine 1,4 cyclohexanededimethanol, 1,2,3, propane triol, 1,6 hexane diol, hydroquinone, N,N,N′,N′ tetrakis (2-hydroxyethyl) ethyl diamine d-glucitol and trimethylol propane.

16. A method of preparing a polyurethane foam comprising the steps of:
admixing an isocyanate prepolymer composition and an isocyanate reactive composition encapsulated in an inert polymer to form a slurry, said isocyanate reactive composition including at least one first polyol and a catalyst;
heating said slurry to a temperature sufficient to at least partially melt said polymer and release said at least one first polyol and said catalyst from said polymer; and
permitting said at least one first polyol to chemically react with isocyanates present in said isocyanate prepolymer composition to form a polyurethane foam.

17. The method according to claim 16, further comprising the step of:
feeding said slurry into an application gun prior to heating said slurry.

18. The method according to claim 17, further comprising the step of mixing said slurry in said application gun.

19. The method according to claim 17, further comprising the step of:
spraying said polyurethane foam to a desired location.

20. The method according to claim 16, wherein said isocyanate prepolymer composition comprises an isocyanate prepolymer and a blowing agent, said isocyanate prepolymer being the reaction product of an isocyanate and at least one second polyol.

21. The method according to claim 20, wherein said isocyanate is selected from the group consisting of methylene-diphenyl-di-isocyanate, polymeric-methylene-diphenyl-di-isocyanate and toluene-diphenyl-di-isocyanate and said one or more second polyols is selected from the group consisting of polyether polyols and polyester polyols.

22. The method according to claim 20, wherein said isocyanate prepolymer composition and said isocyanate reactive composition are present in said slurry in a ratio of from 2:1-30:1 respectively.

23. The method according to claim 20, wherein said isocyanate prepolymer contains less than about 1 wt % free isocyanate monomers.

24. An insulation foam product comprising the reaction product of:
an isocyanate prepolymer composition including an isocyanate prepolymer, and
an isocyanate reactive composition including at least one first polyol and a catalyst, said isocyanate reactive composition being encapsulated in an inert polymer.

25. The insulation foam product according to claim 24, wherein said isocyanate prepolymer composition and said isocyanate reactive composition are present in a ratio of from 2:1-30:1 respectively.

26. The insulation foam product according to claim 24, wherein said isocyanate prepolymer is the reaction product of at least one isocyanate and one or more second polyols.

27. The insulation foam product according to claim 26, wherein said one or more second polyols is a member selected from the group consisting of polyether polyols and polyester polyols.

28. The insulation foam product according to claim 26, wherein said polymer is selected from the group consisting of polyethylene oxide and polypropylene oxide.

29. The insulation foam product according to claim 25, wherein said isocyanate prepolymer is the reaction product of one or more isocyanates and one or more polyamines.

30. The insulation foam product according to claim 24, wherein said isocyanate prepolymer composition further comprises one or more blowing agents.

31. The insulation foam product according to claim 30, wherein said blowing agent acts as a plasticizer to lower the viscosity of said isocyanate prepolymer composition.

32. The insulation foam product according to claim 24, wherein said isocyanate prepolymer composition further comprises at least one member selected from the group consisting of one or more surfactants, flame retardants, colorants and biocides.

33. The insulation foam product according to claim 25, wherein said isocyanate prepolymer has an NCO content of from about 1 to about 15 wt %.

34. The insulation foam product according to claim 24, wherein said isocyanate prepolymer contains less than about 1 wt % free isocyanate monomers.

35. An insulation foam product comprising the reaction product of:
an isocyanate prepolymer composition including an isocyanate prepolymer and one or more first polyols, and
an isocyanate reactive composition including at least one catalyst, said isocyanate reactive composition being encapsulated in an inert polymer.

36. The insulation foam product of claim 35, wherein said isocyanate prepolymer contains less than about 1 wt % free isocyanate monomers.

37. The insulation foam product of claim 35, wherein said isocyanate prepolymer composition further comprises one or more blowing agents.

38. The insulation foam product of claim 37, wherein said isocyanate prepolymer composition further includes at least one member selected from the group consisting of surfactants, flame retardants, colorants and biocides.

39. The insulation foam product of claim 35, wherein said isocyanate prepolymer is the reaction product of at least one isocyanate and one or more second polyols selected from the group consisting of polyether polyols and polyester polyols.

40. The insulation foam product of claim 35, wherein said isocyanate prepolymer is the reaction product of at least one isocyanate and one or more polyamines.

41. The insulation foam product of claim 35, wherein said isocyanate prepolymer composition and said isocyanate reactive composition is present in a ratio of 60:1.

42. The insulation foam product of claim 35, wherein said one or more first polyols is selected from the group consisting of 1,4 butane diol, ethylene diamine 1,4 cyclohexanededimethanol, 1,2,3, propane triol, 1,6 hexane diol, hydroquinone, N,N,N′,N′ tetrakis (2-hydroxyethyl) ethyl diamine d-glucitol and trimethylol propane.

43. The insulation foam product of claim 35, wherein said polymer has a molecular weight of from about 100,000 to about 8,000,000.
